(19) United States
(12) Patent Application Publication
(10) Pub. No.: US 2024/0422253 A1
(43) Pub. Date: Dec. 19, 2024

(54) Mobile Phone Case With Holder

(71) Applicant: Shenzhen DeOne Innovation Technology Co., ltd, Shenzhen Guangdong (CN)

(72) Inventor: Jiongjun Cai, Shenzhen Guangdong (CN)

(21) Appl. No.: 18/533,304

(22) Filed: Dec. 8, 2023

(30) Foreign Application Priority Data
Jun. 16, 2023 (CN) 202321546778.3

(51) Int. Cl. H04M 1/02; H04M 1/12

(52) U.S. Cl. CPC H04M 1/0283; H04M 1/12; H04M 2201/08

(57) ABSTRACT

A mobile phone case with holder is disclosed. The mobile phone case is configured on one side to hold a mobile phone and the other side is configured with a support structure, the support structure includes a holder and a fixed swivel assembled on the mobile phone case. The mobile phone case is configured in a middle with a magnetic region for cooperating with an external magnetic wireless charger, the fixed swivel is arranged between a bottom of the magnetic region and a lower end of the mobile phone case. The mobile phone case has advantages of being able to place the mobile phone case at multiple angles by providing the fixed swivel between the magnetic region and the bottom of the mobile phone case, and also by providing three rotating structures between the fixed swivel and a ring piece.

### TECHNICAL FIELD

The present application relates to the technical field of mobile phone peripherals, and specifically to a mobile phone case with holder.

### BACKGROUND

At present, a mobile phone case with holder is used by more and more mobile phone users, after it is opened, a mobile phone may be supported on a plane to form a certain angle, which is convenient for the users to watch. While a mobile phone case with ring holder not only supports the mobile phone, but also prevents the mobile phone from slipping when it is put on the finger. Moreover, a magnetic region is provided on the mobile phone case, thus the mobile phone may be charged by an external magnetic charger when it is placed in the mobile phone case.

However, the existing mobile phone case with ring holder is often rotated in a single way, for example, only the whole holder may be rotated, but the ring cannot be rotated relative to the whole holder, resulting in only a part of the ring being in contact with the plane, and the stability is poor. Another example is that the whole holder and the ring may be rotated, but the whole holder may only be rotated in one direction, so it is not possible to either lateral support or vertical support at the same time.

### SUMMARY

In view of defects and deficiencies of existing technologies, the present disclosure aims to provide a novelty mobile phone case with holder to achieve advantages that can place the mobile phone case at multiple angles by providing a fixed swivel between a magnetic region and a bottom of the mobile phone case, and also by providing three rotating structures between the fixed swivel and the ring piece.

To realize above objectives, the present disclosure adopts following technical solutions. Specifically, in some embodiments of the present disclosure, a mobile phone case with holder is provided, herein the mobile phone case is configured on one side to hold a mobile phone and the other side is configured with a support structure, the support structure comprises a holder and a fixed swivel assembled on the mobile phone case. The mobile phone case is configured in middle with a magnetic region for cooperating with an external magnetic wireless charger, the fixed swivel is arranged between a bottom of the magnetic region and a lower end of the mobile phone case, and the fixed swivel is configured not to overlap with the magnetic region. The fixed swivel is configured to be rotatable on the mobile phone case along its own centerline, and the fixed swivel is configured with a hinged part. The holder is configured to be connected to the hinged part at one end and rotationally connected to a ring piece at the other end. A rotating centerline of the hinged part is configured at an angle to a rotating centerline of the fixed swivel.

In some embodiments of the present disclosure, the fixed swivel is arranged near the bottom of the magnetic region and correspondingly away from the lower end of the mobile phone case.

In some embodiments of the present disclosure, the fixed swivel includes a rotating block and rotating seat. The rotating block is configured to be affixed to a side of the mobile phone case for placing the mobile phone, and the rotating seat is configured to be affixed to a back of the mobile phone case. A fixed structure is configured between the rotating seat and the rotating block for connecting the two, and the fixed structure pass through the mobile phone case. Longitudinal cross-sectional areas of the rotating seat and the rotating block are both greater than a longitudinal cross-sectional area of the fixed structure.

In some embodiments of the present disclosure, the rotating block and the rotating seat have a disc shape, and the fixed structure has a cylindrical shape.

In some embodiments of the present disclosure, the hinged part includes a hinged seat provided on the fixed swivel and a hinged shaft hinged on the hinged seat, the hinged shaft is configured with a connecting part at one side, the holder is configured with a mounting part, and the connecting part is connected to the mounting part.

In some embodiments of the present disclosure, the connecting part is a connecting plate, and the mounting part is a mounting cavity.

In some embodiments of the present disclosure, the connecting plate is opened with a through hole, the mounting cavity is configured with an aperture at its bottom, and the through hole is configured for a fastener to pass through and into the aperture.

In some embodiments of the present disclosure, the connecting plate is covered with a cover plate to cover the aperture, and the cover plate is shaped to fit the mounting cavity.

In some embodiments of the present disclosure, the mobile phone case is configured with the magnetic region for cooperating with the external magnetic wireless charger.

In some embodiments of the present disclosure, the holder is a support plate provided in a rectangular shape, and a swivel part is configured on an end of the support plate away from the fixed swivel. A notch is opened on one side of the ring piece, and the notch is configured to rotationally connect with the swivel part.

In some embodiments of the present disclosure, the swivel part is a rotating shaft provided on both sides of the support plate, and the notch is configured with a shaft hole for the rotating shaft to pass through.

With adoption of the above technical solutions, the present disclosure has at least following advantages. The middle of the mobile phone case is configured with the magnetic region that can cooperate with the external magnetic wireless charger, and one end of the holder is hinged with the hinged part provided on the fixed swivel so that the holder can rotate relative to the mobile phone case, and such rotation can adjust the angle formed between the whole holder and the mobile phone case. The other end of the holder is provided with the ring piece, which can be rotated with respect to the holder. The fixed swivel is assembled on the mobile phone case, and its specific position is arranged between the magnetic region and the lower end of the mobile phone case, the magnetic region does not overlap to the fixed swivel. Moreover, the fixed swivel is rotated to adjust the entire holder structure in either vertical support mode or lateral support mode. By such designs, the whole support structure can support the mobile phone case on the plane, and its support modes include vertical support and the lateral support, the ring piece can also be worn by a finger, so that the user can pick up or hold the mobile phone firmly via the ring piece.

### BRIEF DESCRIPTION OF THE DRAWINGS

In order to more clearly illustrate the technical solutions in embodiments of the present disclosure and the existing technologies, the following will briefly describe accompanying drawings that need to be used in the description of the embodiments or the existing technologies. It will be obvious that the accompanying drawings in the following description are only some of the embodiments of the present disclosure, and for one person of ordinary skill in the art, other accompanying drawings can be obtained based on these drawings without paying creative labor.

FIG. 1 is a structural schematic diagram of a mobile phone case with holder in accordance with some embodiments of the present disclosure.

FIG. 2 is a structural schematic diagram of a magnetic region in accordance with some embodiments of the present disclosure.

FIG. 3 is a structural schematic diagram of a support structure in accordance with some embodiments of the present disclosure.

FIG. 4 is a structural schematic diagram of a holder in accordance with some embodiments of the present disclosure.

FIG. 5 is another structural schematic diagram of a mobile phone case with holder in accordance with some embodiments of the present disclosure.

In the drawings, reference signs are as follows. 1. mobile phone case, 11. keyaps, 12. exposed groove, 13. magnetic region, 2. fixed swivel, 21. rotating block, 22. fixed structure, 23. rotating seat, 24. hinged part, 25. connecting part, 251. hinged shaft, 252. connecting plate, 253. through hole, 3. holder, 31. support plate, 311. mounting cavity, 312. aperture, 32. mounting part, 321. cover plate, 33. swivel part, 4. ring piece.

### DETAILED DESCRIPTION OF THE EMBODIMENTS

The present disclosure will be described in further detail below in conjunction with the accompanying drawings.

Specific embodiments are only an explanation of the present disclosure, which is not a limitation of the present disclosure, after reading of this specification the person of ordinary skill in the art can make modifications to the embodiments without creative contribution as needed, which are protected by the patent law as long as it falls within the scope of the claims of the present disclosure.

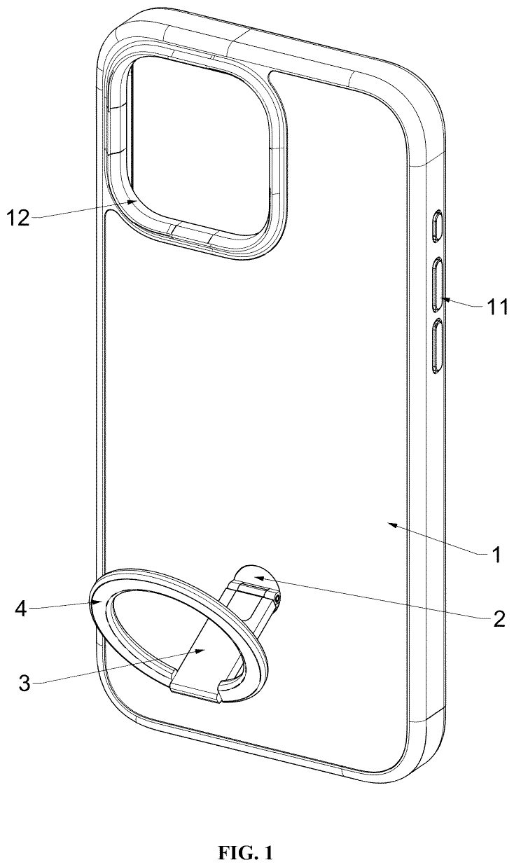

In some embodiments of the present disclosure, a mobile phone case 1 with holder is provided. Referring to FIG. 1, a main body of this device is the mobile phone case 1, and the mobile phone case 1 includes a bottom and a side arranged around the bottom. The bottom is attached to a back of the mobile phone case 1, and the side is attached to sides of the mobile phone case 1. The bottom is configured with an exposed groove 12 for cameras of a mobile phone to be exposed, and the side is configured with a keycaps 11 adapted to keys on the side of the mobile phone. In some examples, the side and the bottom are made of different materials, such as the side is made of opaque materials, which may be rubber or other plastic materials. The bottom is made of transparent materials, which may be silicone or other plastic materials. In some other examples, it may also be that the bottom is opaque and the side is transparent, the bottom and the side are both transparent, or the bottom and the side are both opaque.

It is to be added that the side are glued or embedded with the bottom, or may be integrally molded. In some other embodiments, the mobile phone case 1 is not configured with the side but only the bottom is glued to the back of the mobile phone.

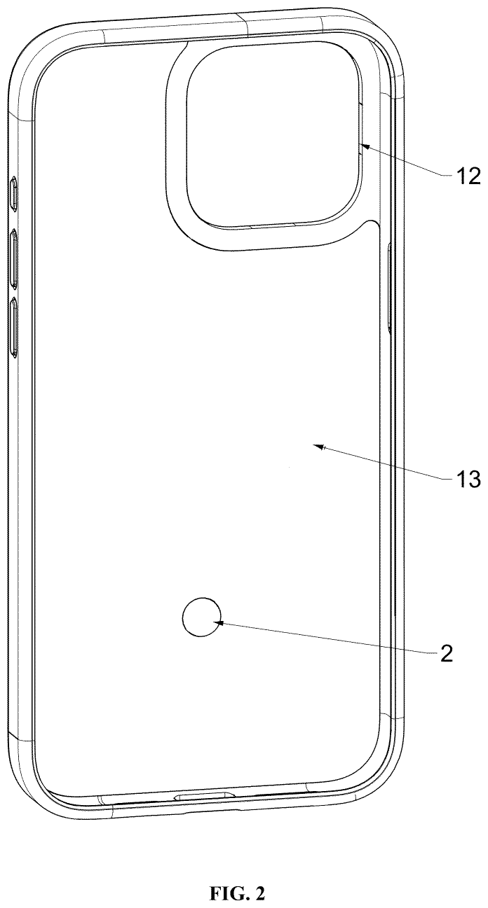

Referring to FIG. 2, a magnetic region 13 is configured on the side of the mobile phone case 1 for the mobile phone to be placed in, and the magnetic region 13 is used to cooperate with an external magnetic wireless charger, so as to facilitate charging of the mobile phone. In addition, the magnetic region 13 is adapted to a wireless charging portion of the mobile phone, specifically, the magnetic region 13 is provided in a center of the mobile phone case 1. In some embodiments, the magnetic region is not provided with a magnet but corresponds to the wireless charging portion of the mobile phone for wireless charging of the mobile phone by the external magnetic wireless charger.

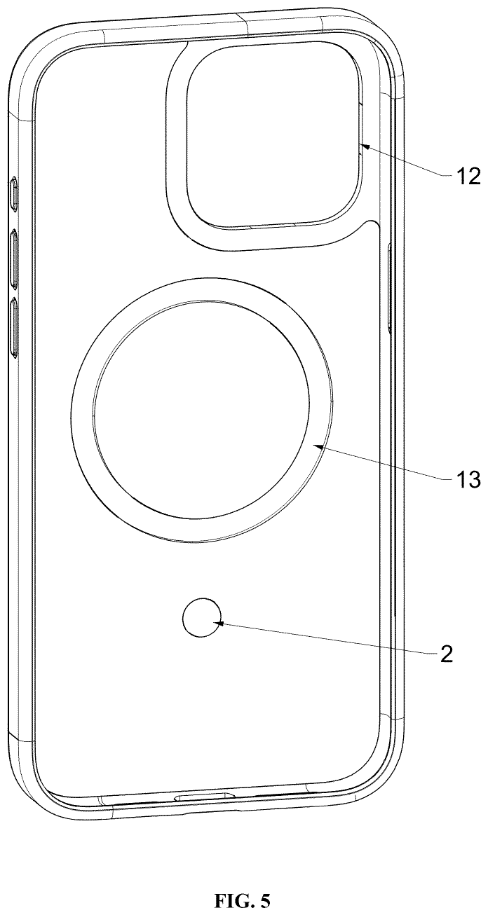

Referring to FIG. 5, in some other embodiments, the magnetic region 13 is arranged by a plurality of magnets lined up on the mobile phone case 1 to form a ring, and the magnets are covered with a protective ring to prevent the magnets from being exposed. In some another embodiments, the magnets are provided on the back of the mobile phone case 1 or internally installed in the mobile phone case 1, in this case the magnets are not exposed, and there is no need to provide a protective ring.

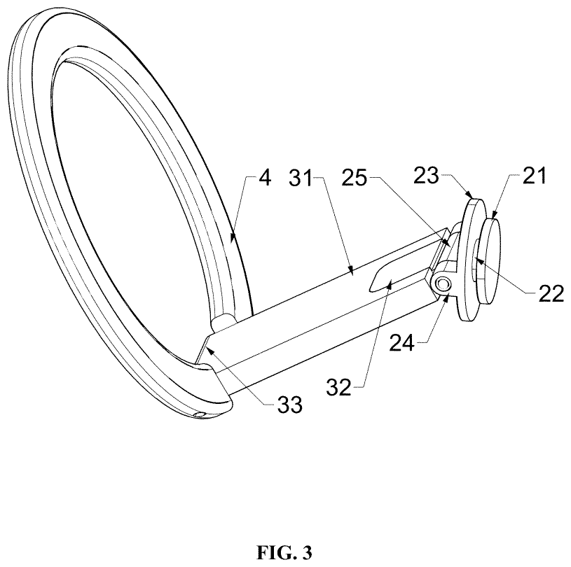

Referring to FIG. 1 to FIG. 3, one side of the mobile phone case 1 is for the mobile phone to be placed, and the other side is configured with a support structure, and three rotating structures are provided on the support structure, so that the support structure can support the mobile phone case 1 on the plane, and the support modes include vertical support and the lateral support.

In some preferred embodiments, the support structure includes a holder 3, a fixed swivel 2 and a ring piece 4. One end of the holder 3 is rotationally connected to the mobile phone case 1 by the fixed swivel 2, thus the holder 3 is rotatable with respect to the mobile phone case 1, and such rotation can adjust an angle formed between the entire holder 3 and the mobile phone case 1. The other end of the holder 3 is rotationally provided with the ring piece 4, the ring piece 4 is rotatable with respect to the holder 3, and its rotation axis is provided in parallel with the rotation axis of the holder 3.

It is to be added that the fixed swivel 2 is assembled on the mobile phone case 1, which is rotatable on the mobile phone case 1 along its own centerline, and its rotation can adjust the whole holder structure to be in the vertical support mode or in the lateral support mode. The fixed swivel 2 is configured with a hinged part 24, and one end of the holder 3 is connected to the hinged part 24, so as to realize the rotating connection between the holder 3 and the mobile phone case 1. A rotating centerline of the hinged part 24 is configured at an angle to a rotating centerline of the fixed swivel 2, specifically, the rotating centerline of the hinged part 24 is perpendicular to the rotating centerline of the fixed swivel 2.

In some embodiments, the fixed swivel 2 is provided in a portion between the magnetic region 13 and the bottom of the mobile phone case 1, and the fixed swivel 2 does not overlap the magnetic region 13. Specifically, the fixed swivel 2 is provided on a side close to the magnetic region 13 but correspondingly away from the bottom of the mobile phone case 1, and the fixed swivel 2 in this position is available for the holder 3 and the ring piece 3 to be used without affecting the use of the magnetic region 13 when the holder 3 and the ring piece 4 are supported in the vertical support or in the lateral support, and is more convenient to use.

It is to be noted that when the finger puts on the ring piece 4, the user can pick up or hold the mobile phone securely by the ring piece 4. When the support structure is in a support state on the plane, the ring piece 4 can also be rotated to make the entire ring body of the ring piece 4 fit the plane, so as to make the support state of the support structure more stable.

In some preferred embodiments, the fixed swivel 2 includes a rotating block 21 and a rotating seat 23. The rotating block 21 is configured to be affixed to a side of the mobile phone case 1 for placing the mobile phone, and the rotating seat 23 is configured to be affixed to a back of the mobile phone case 1. A fixed structure 22 is configured between the rotating seat 23 and the rotating block 21 for connecting the two, and the fixed structure 22 pass through the mobile phone case 1, thus the bottom of the mobile phone case 1 is clamped by the rotating seat 23 and the rotating block 21. And at this time, the fixed structure 22 can be used as a rotating shaft of the rotating seat 23 and the rotating block 21, so that the rotating seat 23 and the rotating block 21 can be rotated on the mobile phone case 1. Further, longitudinal cross-sectional areas of the rotating seat 23 and the rotating block 21 are both greater than a longitudinal cross-sectional area of the fixed structure 22.

In some embodiments, the rotating block 21 and the rotating seat 23 have a disc shape, the fixed structure has a cylindrical shape, and the entire fixed structure 22 has an I-cross section. The mobile phone case 1 is provided with embedding slots for the rotating block 21 and the rotating seat 23 to be embedded. In some other embodiments, the mobile phone case 1 is not provided with the embedding slots.

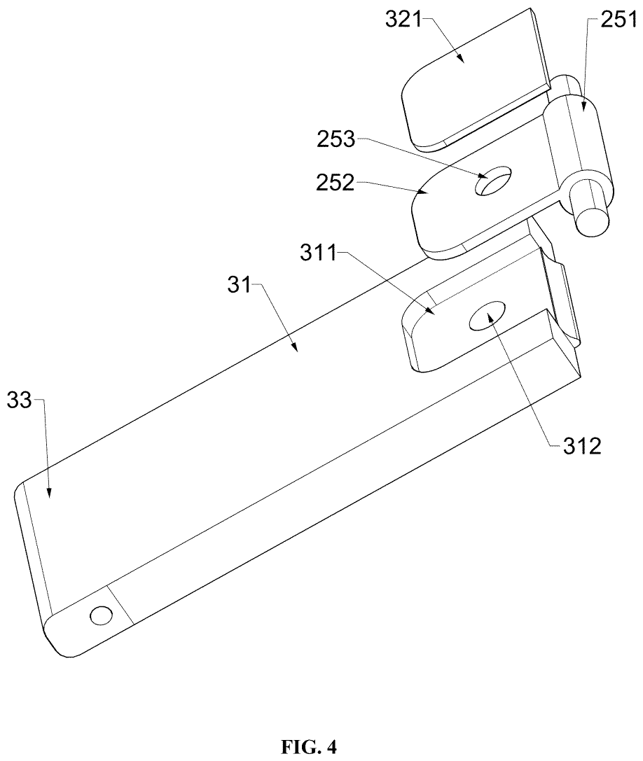

Referring to FIG. 4, the hinged part includes a hinged seat provided on the fixed swivel 2 and a hinged shaft 251 hinged on the hinged seat. The hinged seat is specifically two shaft seats opposite to each other, the hinged shaft 251 is specifically the rotating shaft passed through the two shaft seats, and a connecting part 25 is provided on one side of the rotating shaft. The holder 3 is provided with a mounting part 32, the connecting part 25 is connected to the mounting part 33, which makes the holder 3 hinged on the fixed swivel 2.

In some embodiments, the connecting part 25 is a connecting plate 252, which is provided in a form of a sheet. The mounting part 32 is a mounting cavity 311, which is also opened in the form of a sheet. The mounting cavity 311 has openings on both sides, one of which is a side and the other of which is a top surface, so as to be available for the connecting plate 252 to be placed therein. It should be noted that a depth of the mounting cavity 311 is greater than a thickness of the connecting plate 252.

It is to be added that the connecting plate 252 is provided with a through hole 253, and the bottom of the mounting cavity 311 is provided with an aperture 312. When the connecting plate 252 is placed in the mounting cavity 311, the through hole 253 is aligned with the aperture 312, and the through hole 253 is available for a fastener to be passed through and placed in the aperture 312, thereby can realize the connecting plate 252 is fixedly assembled within the mounting cavity 311, so as to hinge the holder 3 to the fixed swivel 2.

In some embodiments, the connecting plate 252 is covered with a cover plate 321 to cover the aperture 312, and the cover plate 321 is shaped to fit the mounting cavity 311. By such designs, it not only can cover the aperture 312 on the connecting plate 252, but also the entire connecting plate 252. Therefore the product as a whole is more aesthetically pleasing and also serves to protect the connecting plate 252. The connection between the cover plate 321 and the connecting plate 252 is preferably glued. And in some other embodiments, the cover plate 321 is clamped into the mounting cavity 311. In some another embodiments, the mounting cavity 311 is opened on one side only, that is, the mounting cavity 311 is opened on the side, and the side opening is only necessary to insert the connecting plate 252 and subsequently fill in a sealant for gluing, which can realize the connecting plate 252 is fixedly assembled within the mounting cavity 311.

In some preferred embodiments, the holder 3 is a support plate 31 provided in a rectangular shape, and a swivel part 33 is configured on an end of the support plate 31 away from the fixed swivel 2. A notch is opened on one side of the ring piece 4, and the notch is configured to rotationally connect with the swivel part 33. The swivel part 33 is the rotating shaft provided on both sides of the support plate 31, and the notch is provided with the shaft hole for the rotating shaft to pass through.

The above description only for the purpose of illustrating the technical solutions of the present disclosure rather than limitation, other modifications or equivalent substitutions made to the technical solutions of the present disclosure by the person of ordinary skill in the art, as long as they do not deviate from the spirit and scope of the technical solutions of the present disclosure, should be covered by the scope of the claims of the present disclosure.

What is claimed is:

1. A mobile phone case with holder, wherein
the mobile phone case (1) is configured on one side to hold a mobile phone and the other side is configured with a support structure, the support structure comprises a holder (3) and a fixed swivel (2) assembled on the mobile phone case (1);
the mobile phone case (1) is configured in a middle with a magnetic region (13) for cooperating with an external magnetic wireless charger, the fixed swivel (2) is arranged between a bottom of the magnetic region (13) and a lower end of the mobile phone case (1), and the fixed swivel (2) is configured not to overlap with the magnetic region (13);
the fixed swivel is configured to be rotatable on the mobile phone case (2) along its own centerline, and the fixed swivel (2) is configured with a hinged part (24);
the holder (3) is configured to be connected to the hinged part (24) at one end and rotationally connected to a ring piece (4) at the other end; and
a rotating centerline of the hinged part (24) is configured at an angle to a rotating centerline of the fixed swivel (2).

2. The mobile phone case with holder according to claim 1, wherein the fixed swivel (2) is arranged near the bottom of the magnetic region (13) and correspondingly away from the lower end of the mobile phone case (1).

3. The mobile phone case with holder according to claim 1, wherein the fixed swivel comprises,
a rotating block (21), configured to be affixed to a side of the mobile phone case (1) for placing the mobile phone; and
a rotating seat (23), configured to be affixed to a back of the mobile phone case (1);
wherein a fixed structure (22) is configured between the rotating seat (23) and the rotating block (21) for connecting them, and the fixed structure (22) pass through the mobile phone case (1); and
wherein longitudinal cross-sectional areas of the rotating seat (23) and the rotating block (21) are both greater than a longitudinal cross-sectional area of the fixed structure (22).

4. The mobile phone case with holder according to claim 3, wherein the rotating block (21) and the rotating seat (23) have a disc shape, and the fixed structure has a cylindrical shape.

5. The mobile phone case with holder according to claim 1, wherein the hinged part (24) comprises a hinged seat provided on the fixed swivel (2) and a hinged shaft (251) hinged on the hinged seat, the hinged shaft (251) is configured with a connecting part (25) at one side, the holder (3) is configured with a mounting part (32), and the connecting part (25) is connected to the mounting part (32).

6. The mobile phone case with holder according to claim 5, wherein the connecting part (25) is a connecting plate (252), and the mounting part (32) is a mounting cavity (311).

7. The mobile phone case with holder according to claim 6, wherein the connecting plate (252) is opened with a through hole (253), the mounting cavity (311) is configured with an aperture (312) at its bottom, and the through hole (253) is configured for a fastener to pass through and into the aperture (312).

8. The mobile phone case with holder according to claim 7, wherein the connecting plate (252) is covered with a cover plate (321) to cover the aperture (312), and the cover plate (321) is shaped to fit the mounting cavity (311).

9. The mobile phone case with holder according to claim 1, wherein the holder (3) is a support plate (31) provided in a rectangular shape, and a swivel part (33) is configured on an end of the support plate (31) away from the fixed swivel (2); a notch is opened on one side of the ring piece (4), and the notch is configured to rotationally connect with the swivel part (33).

10. The mobile phone case with holder according to claim 9, wherein the swivel part (33) is a rotating shaft provided on both sides of the support plate (31), and the notch is configured with a shaft hole for the rotating shaft to pass through.
